(19) United States
(12) Patent Application Publication
(10) Pub. No.: US 2026/0199056 A1
(43) Pub. Date: Jul. 16, 2026

(54) Dental instrument station with magnetic retention

(71) Applicant: Tito Molina, Katy, TX (US)

(72) Inventor: Tito Molina, Katy, TX (US)

(21) Appl. No.: 19/016,467

(22) Filed: Jan. 10, 2025

(51) Int. Cl. A61C 1/14

(52) U.S. Cl. CPC A61C 1/145; A61C 2204/00

(57) ABSTRACT

A dental instrument station includes a bar having one or more receptacles defined therein, and one or magnets disposed within the bar. The one or more magnets provide a magnetic force at some or all of the receptacles defined in the bar and are dimensioned to cause the magnetic force to be sufficiently strong to hold a dental instrument of predetermined weight in position within a respective receptacle, and to be sufficiently low to enable a dental clinician to remove the dental instrument using only a light pull. The dental instrument may be attached to a ring that is arranged at an end of a tube that extends from a dental instrument cart and that is made of a magnetic material.

### FIELD OF THE INVENTION

The present invention relates to a dental instrument station that includes a bar having one or more receptacles defined therein, and one or more magnets disposed within the bar. More particularly, the present invention relates to a dental instrument station having one or more magnets arranged to provide a magnetic attraction at some or all of the receptacles defined in the bar and dimensioned to cause the magnetic attraction to hold a dental instrument of predetermined weight in position within the respective receptacle.

### BACKGROUND OF THE INVENTION

Dental instrument stations are used in dental practices to retain a variety of instruments used by dental clinicians, for example, high vacuum evacuators, saliva ejector vacuum valves, water syringes, and different types of handpieces. Such dental instrument stations are configured to store the dental instruments when not in use and make the same dental instruments readily available to the dental clinician when so required.

Dental instrument stations known in the art include a bar or a mount having instrument holders on one side. Those instrument holders may be shaped as receptacles 10 defined on one side of the bar or mount, as shown in FIG. 1, or may be provided as shaped attachments 12 on one side of the bar or mount, as shown in FIG. 2.

The dental instruments that are retained in dental instruments stations are all made of metal, typically stainless steel or metal alloys, or at the very least contain metallic parts. Those instruments are engaged in the respective instrument holders by mechanical action, because the instrument holders are shaped as slots that partially surround the respective instrument and keep it in place by interference fit until the dental clinician extracts the dental instrument from its holder.

One drawback of the dental instrument stations known in the art is that extracting and later repositioning a dental instrument requires time, which should be minimized to increase the productivity of the dental practice.

Moreover, the dental clinician may occasionally have an imperfect grip on the dental instrument during removal from the respective holder, or, conversely, may reposition the dental instrument improperly in its holder after use. In either case, the dental instrument falls on the floor, becoming contaminated and causing the dental clinician to disconnect it, remove it from the instrument station, replace it with a sterilized instrument, and send the contaminated dental instrument for cleaning and sterilization. This type of incident causes additional increases in cost and downtime and further affects the productivity of the dental practice.

### SUMMARY OF THE INVENTION

A dental instrument station according to the invention includes a bar having one or more receptacles defined therein, and one or magnets disposed within the bar. The one or more receptacles exercise a magnetic attraction to a dental instrument positioned therein, the magnetic attraction being caused by the magnetic force of one or more magnets disposed within the bar. That magnetic attraction is sufficiently high to retain the dental instrument in position but is also sufficiently low to allow the detachment of the dental instrument from the receptacle without the use of excessive force, for example, without causing excessive vibrations within the dental instrument station.

In different embodiments of the invention, a single magnet may be disposed within the bar, or individual magnets are arranged in the proximity of at least some of the receptacles, and those individual magnets may be of the same or different sizes and shapes, so as to generate the same or different levels of magnetic attraction within each respective receptacle.

One or more sensors may also be provided that alert of a decrease in the level of magnetic attraction below a predetermined threshold and that may generate an alarm signal when such a drop is experienced. In different embodiments of the invention, the alarm signal may be acoustic or visual. For example, one or more lights may be provided on the bar that indicate whether the receptacles have a magnetic force applied thereto or whether the magnetic force has dropped below a predetermined level.

Alternatively, or additionally, the dental instrument station may also include a display panel that provides information on operation of the dental instrument station, as well as alerts when the magnetic force falls below a predetermined level. The display panel may be attached to the dental instrument station or may be separate, for example, may be provided on an instrument cart to which the dental instrument station is affixed.

More generally, the dental instrument station may be affixed to a dental instrument cart that includes one or more tubes, to which individual dental instruments may be engaged. The one or more tubes may include a portion made of a magnetic metal, which can become attached to a receptable (for example, a flat receptacle) in the dental instrument station. For example, the portion made of magnetic metal can be configured as a ring arranged at an end of a tube that is shaped to engage the dental instrument.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 shows a dental instrument station according to the prior art.

FIG. 2 shows another dental instrument station according to the prior art.

FIG. 3 shows a dental instrument station according to the invention.

FIG. 4 shows the dental instrument station of FIG. 3 but having different types of magnets.

FIG. 5 shows a dental instrument station according to the invention affixed to a dental instrument cart.

FIG. 6 shows a tube configured to be attached to a dental instrument cart and having a portion, shaped as a ring for engaging a dental instrument, which is made of a magnetic metal.

FIG. 7 shows the tube of FIG. 6 with the dental instrument engaged thereto, and with the magnetic metal ring engaged to a dental instrument station according to the invention.

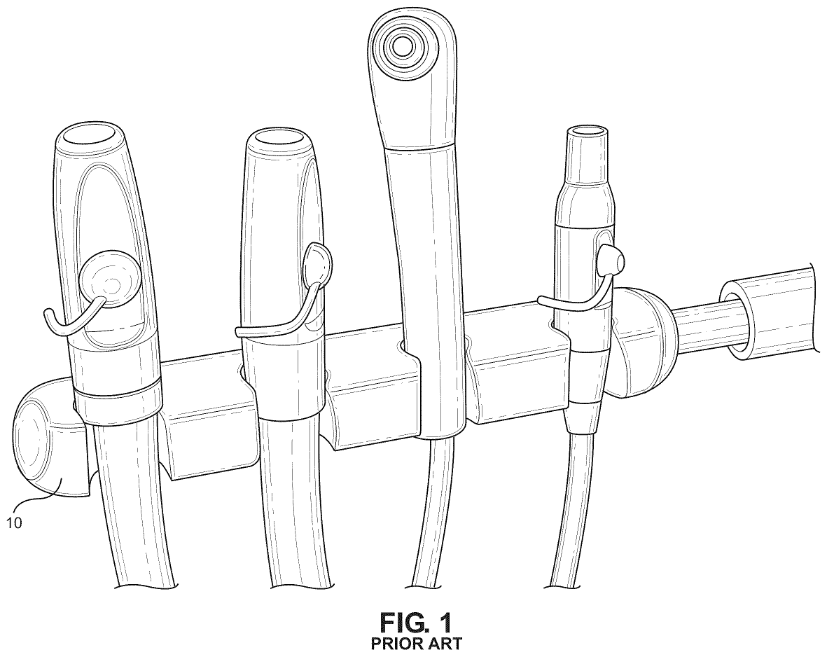

### DETAILED DESCRIPTION OF EMBODIMENTS OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any system, structure, or manner.

In general, a dental instrument station according to the invention is structured to retain dental instruments by magnetic force rather than by mechanical constraint.

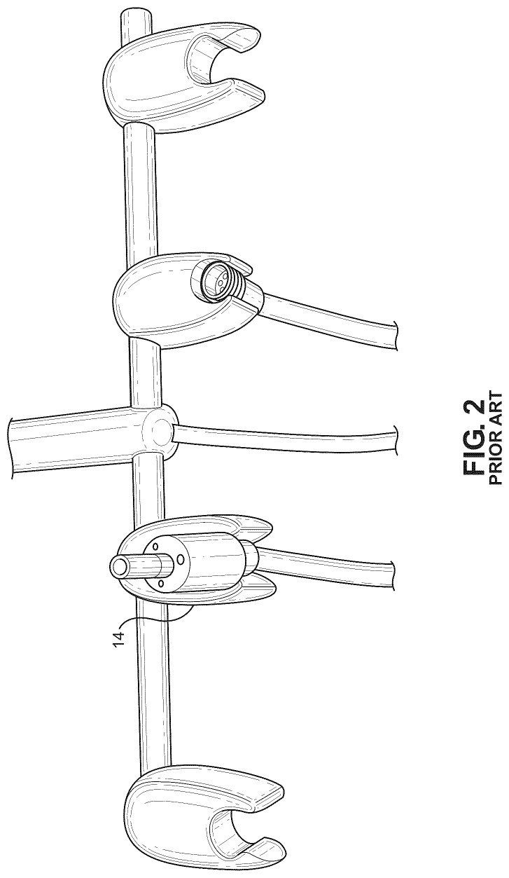

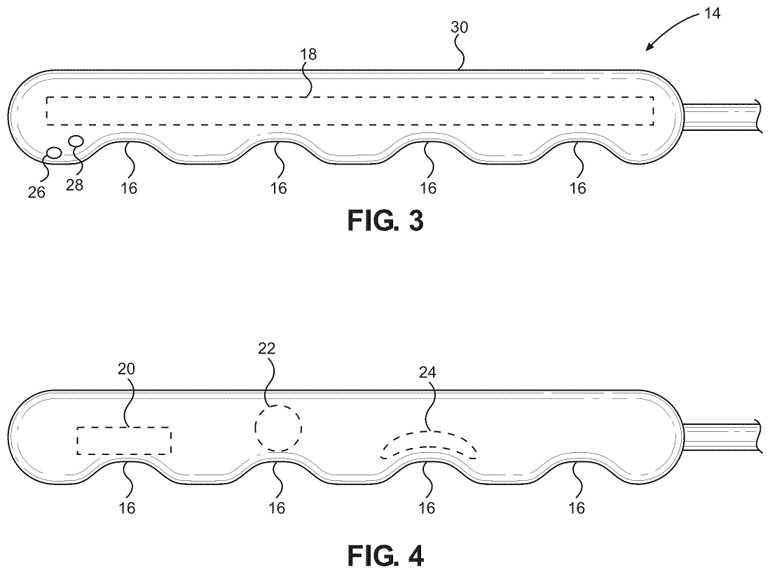

In one embodiment, depicted in FIG. 3, dental instrument station 14 includes a bar 30 having one or more receptables 16 defined therein, which are structured to retain a dental instrument by the magnetic attraction caused by a magnetic force. While the bar depicted in FIG. 3 has a linear shape, in other embodiments of the invention bar 30 may have different shapes, for example, may have a semi-circular or a “S” shape. Further, while FIG. 3 depicts a bar shaped as a single object, “bar” in the present description is intended to include a plurality of elements, such as bars that are made of a plurality of segments or bars that are made of linear segments with instrument holders attached to that linear segment in the manner shown in FIG. 2.

In different embodiments of the invention, only some of receptacles 16 may exert a magnetic attraction while other receptacles may retain a dental instrument by interference fit like in the prior art. Those receptacles 16 that provide a magnetic attraction are preferably shaped to be shallower than the receptacles in dental instrument stations according to the prior art, so as to enable a dental clinician to extract a dental instrument from, a reposition the dental instrument into, a receptacle more easily than in dental stations according to the prior art.

In different embodiments of the invention, receptacles 16 may have different shapes. For example, receptacles 16 may have an arcuate outer shape and be shaped as arched receptacles, or may be shaped as slots, or simply have a planar shape so as be shaped as plates, which extend outwardly from bar 30 or are simply a portion of 30, and to which a dental instrument is attracted and remains engaged by virtue of magnetic attraction.

The magnetic attraction is generated by the magnetic force of one or more magnets that are embedded within bar 30. In one embodiment of the invention, depicted in FIG. 3, the magnetic attraction is generated by a single magnet 18, which extends lengthwise within bar 30, and which provides a magnetic force within at least some of receptacles 16. In another embodiment of the invention, instead, the magnetic attraction is generated by individual magnets 20, 22, 24, which are positioned within, or adjacently, to each receptacle 16 where the magnetic attraction is desired, as shown in FIG. 4.

In either case, the magnetic attraction generated within receptacles 16 must be sufficient to hold a dental instrument of predetermined weight in position within the corresponding receptacle, so that the dental clinician can store a dental instrument within a desired receptacle by simply laying the dental instrument against a wall of the receptacle. At the same time, the magnetic attraction must not be excessive so that the dental clinician can remove the dental instrument from the holding receptacle only by exerting a light force and without causing excessive vibrations in the dental instrument holder.

When individual magnets 20, 22, 24 are employed, those magnets may all be of the same size and shape or have different sizes and shapes depending on individual requirements for the corresponding receptacle 16. For example, the individual magnets may have different dimensions to provide different degrees of magnetic attraction, and may be shaped as bars 20, disks 22, or crescents 24.

In one embodiment, a sensor 26 may be provided that detects whether a magnet experiences a decrease in magnetic force, for example, becomes demagnetized. Sensor 26 may then generate an alert that can be issued in different manners, for example, acoustically or visually.

In one embodiment, an acoustic alert may be triggered when sensor 26 detects a drop in magnetic force below a predetermined level.

In another embodiment, a LED light 28 may be connected to sensor 26 and become illuminated when sensor 26 detects a drop in magnetic force below a predetermined level. Conversely, light 28 may be illuminated during normal operation and may be turned off, blink, or change color when a drop in magnetic force is detected by sensor 26.

While one such sensor 26 is shown in FIG. 3, a person of skill in the art will appreciate that more than one sensor 26 may be provided for the embodiment of FIG. 4, for example, a sensor may be positioned in the proximity of each magnet or in other locations. Likewise, FIG. 3 shows a single LED light 28 but more than one LED light 28 may be provided. For example, when a plurality of sensors 26 is provided, a LED light 28 next to each sensor may also be provided.

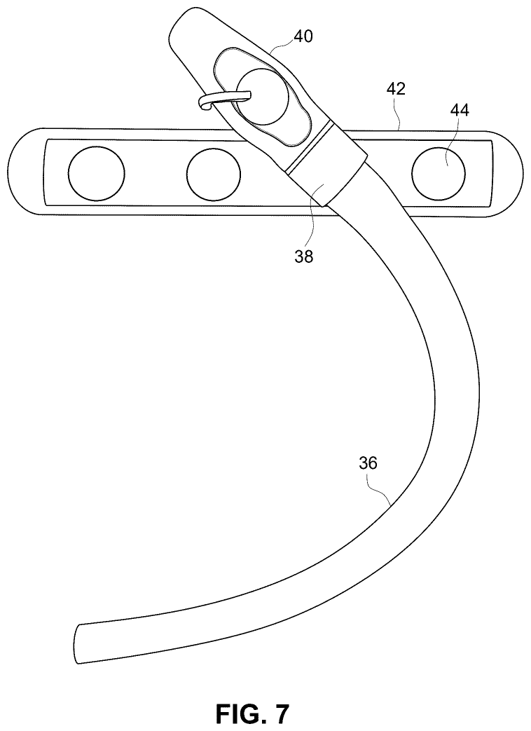

While FIGS. 3 and 4 depict semicircular receptacles 16, in different embodiments of the invention, receptacles 16 may have other shapes such as elliptical or rectangular, but still include one or more magnets that provide a magnetic attraction of sufficient strength along at least one edge of the instrument station to retain the dental instruments engaged along that edge. FIG. 7 shows instead receptacles having a planar outer face, to which a tube 36 carrying a dental instrument 40 is attached.

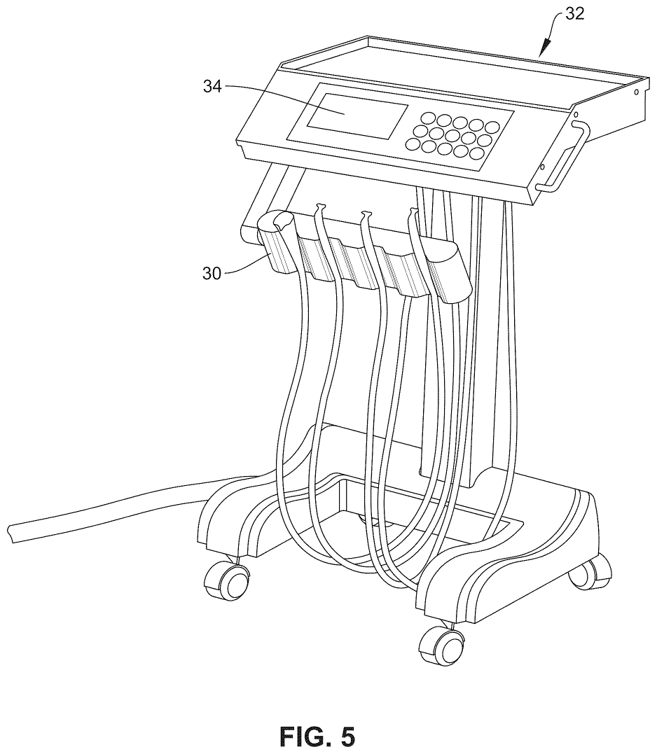

A dental instrument station according to the invention may also include a visual display that provides information on the status of the dental instrument station. In one embodiment, depicted in FIG. 5, bar 30 may be affixed to a cart 32 which, in addition to bar 30, includes a visual display 34 that provides different types of information, including information on the operational status of bar 30, in particular, the level of magnetic force provided at each receptacle 16.

In the event of a drop in magnetic force at bar 30 below a predetermined level, visual display 34 signals that drop in magnetic force and may alert the dental clinician in different manners, for example, with a blinking display, or with a change in color, or by triggering an acoustic alarm.

While cart 32 is shown in FIG. 5 as a movable cart with casters, within the present context “cart” should be interpreted in a broader sense and include accessories of a dental chair where instruments can be held, for example, trays connected to a dental chair by a movable arm.

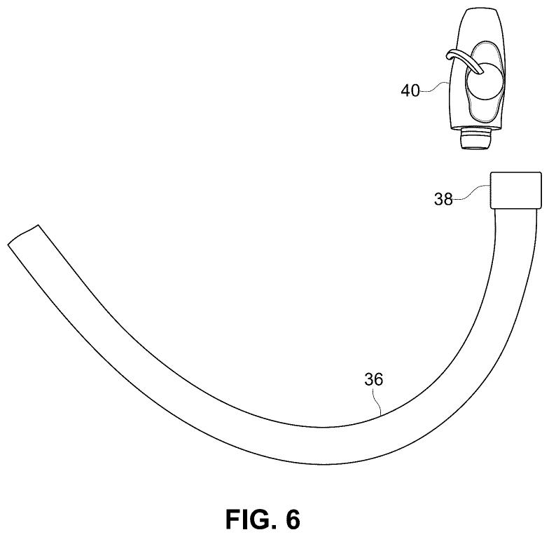

Cart 32 may include one or more tubes, to which dental instruments are attached, and which may include a portion made of a magnetic material that is attracted to bar 30. For example, as shown in FIG. 6, one or more tubes 36 may have a free end configured as a ring 38, which is made of a magnetic material and to which a dental instrument 40 can be attached. The magnetic material may be ferromagnetic or magnetically soft.

FIG. 7 shows a bar 42 according to the invention, which includes a plurality of magnets 44 that have a planar surface, to which ring 38 can become attached.

While the invention has been described in connection with the above-described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

The invention claimed is:

1. A dental instrument station comprising:
a bar having one or more receptacles defined therein; and
one or magnets disposed within the bar,
wherein the one or more magnets are arranged to provide a magnetic attraction at at least some of the one or more receptacles and are dimensioned to cause the magnetic attraction to hold a dental instrument of predetermined weight in position within one of the one or more receptacles.

2. The dental instrument station according to claim 1, wherein the one or magnets are a single magnet extending within the bar and generating the magnetic attraction at the at least some of the one or more receptacles.

3. The dental instrument station according to claim 1, wherein the one or magnets are a plurality of magnets each positioned at one of the at least some of the one or more receptacles.

4. The dental instrument station according to claim 3, wherein the plurality of magnets comprises magnets having different levels of the magnetic attraction.

5. The dental instrument station according to claim 3, wherein the plurality of magnets comprises magnets having different shapes.

6. The dental instrument station according to claim 1, wherein the one or more receptacles have an arcuate outer shape.

7. The dental instrument station according to claim 1, wherein the one or more receptacles have a planar outer shape.

8. The dental instrument station according to claim 1, further comprising sensors alerting of a drop in the magnetic attraction.

9. The dental instrument station according to claim 8, further comprising an acoustic emitter providing an acoustic alert when the magnetic attraction falls below a predetermined level.

10. The dental instrument station according to claim 8, further comprising individual lights positioned at each of the at least some of the one or more receptacles, the individual lights being lit when the magnetic attraction is operating and becoming dark or changing color when the magnetic attraction falls below a predetermined level.

11. The dental instrument station according to claim 8, further comprising a display panel providing information on operation of the dental instrument station, the information comprising an alert of the drop in the magnetic attraction.

12. The dental instrument station according to claim 11, further comprising a dental instrument cart to which the bar is affixed, wherein the display panel is provided on the dental instrument cart.

13. The dental instrument station according to claim 1, further comprising a dental instrument cart to which the bar is affixed, wherein the dental instrument cart comprises one or more tubes configured to engage the dental instrument, and wherein the one or more tubes comprise a portion made of a magnetic metal.

14. The dental instrument station according to claim 13, wherein the portion made of the magnetic metal is configured as a ring arranged at an end of the one or more tubes, the ring being configured to engage the dental instrument.
